(19) United States
(12) Patent Application Publication
(10) Pub. No.: US 2025/0020063 A1
(43) Pub. Date: Jan. 16, 2025

(54) SELECTIVE REMOVAL OF COATINGS FROM COOLING POCKETS OF TURBINE BLADES

(71) Applicant: Siemens Energy Global GmbH & Co. KG, Munich, Bayern (DE)

(72) Inventors: Jan Philipp Borrmann, Köln (DE); Benjamin Lippke, Falkensee (DE)

(73) Assignee: Siemens Energy Global GmbH & Co. KG, Munich, Bayern (DE)

(21) Appl. No.: 18/713,655

(22) PCT Filed: Oct. 31, 2022
(86) PCT No.: PCT/EP2022/080342

§ 371 Date: May 26, 2024

(30) Foreign Application Priority Data
Nov. 30, 2021 (DE) 10 2021 213 531.5

(51) Int. Cl. F01D 5/28; B24C 1/04

(52) U.S. Cl. CPC F01D 5/288; B24C 1/04; F01D 5/284; F05D 2230/10; F05D 2300/175; F05D 2300/2112; F05D 2300/611

(57) ABSTRACT

A method for selectively removing a ceramic coating from adjacent cooling pockets of a turbine blade, wherein a high-speed water jet is used to at least partially remove ceramic material from at least one pocket in the region of a trailing edge of the turbine blade and/or from ribs between the pockets, and a metal adhesive layer being applied to the turbine blade.

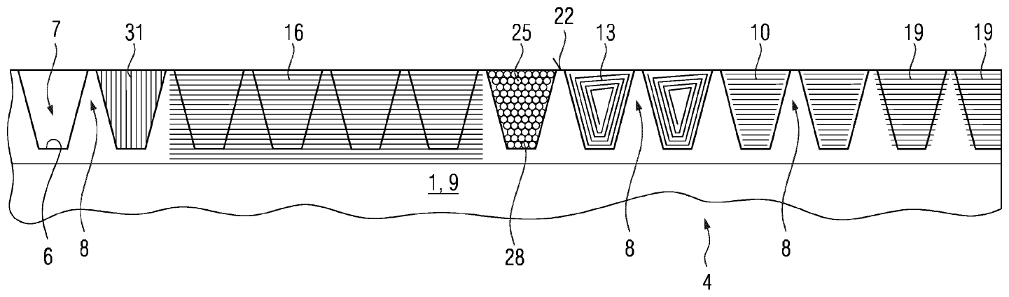

### CROSS REFERENCE TO RELATED APPLICATIONS

This application is the US National Stage of International Application No. PCT/EP2022/080342 filed 31 Oct. 2022, and claims the benefit thereof, which is incorporated by reference herein in its entirety. The International Application claims the benefit of German Application No. DE 10 2021 213 531.5 filed 30 Nov. 2021.

### FIELD OF INVENTION

The invention relates to the selective removal of coatings, such as a ceramic coating (TBC) in particular, from the pockets (“fans”) on the trailing edge of turbine blades by means of water jet removal, and to turbine blades.

### BACKGROUND OF INVENTION

Such designs are known from U.S. Pat. No. 6,258,226 B1 or U.S. Pat. No. 7,939,135 B2.

In the coating process of the ceramic thermal barrier coating (TBC) by means of plasma spraying, the trailing edge of turbine rotor blades and turbine guide vanes is covered by means of a metal sheet in order to prevent “clogging” of the cooling air bores, including fan geometry.

As the covering metal sheet is being removed, the TBC sometimes chips off, making rework or recoating necessary.

Furthermore, the ribs between the individual, fan-shaped cooling air outlets cannot be coated with a TBC, because the ribs are also covered.

This results in an increased, undesired heat input into the base material.

### SUMMARY OF INVENTION

Therefore, an object of the invention is to solve the aforementioned problem.

The object is achieved by a method as claimed and by a turbine blade as claimed.

The dependent claims list additional advantageous measures, which can be combined with one another in any way in order to achieve additional advantages.

### BRIEF DESCRIPTION OF THE DRAWINGS

The FIGURE shows multiple exemplary embodiments of the invention.

The FIGURE and the description present only exemplary embodiments of the invention.

### DETAILED DESCRIPTION OF INVENTION

Turbine blades have a trailing edge, which can have pockets, i.e. fan-shaped cooling air outlets.

During the coating of the turbine blade, a metallic bond coat for a TBC, in particular an MCrAl—X coat—M=Ni, Co, Fe; X optionally=Y, Ta, Re, and/or Si—is applied without masking, so that the pockets and the ribs between pockets also have the metallic coat like a blade airfoil.

Thereafter, the turbine blade is coated with a ceramic (TBC), which likewise precipitates on the ribs and on the pockets and has a certain coat thickness in the pockets.

Processing by means of electron beams, laser beams or high-velocity water jets—with or without the addition of abrasive particles—allows selective removal of a coat, in particular a ceramic coat, of the TBC.

Accordingly, an outlet edge no longer has to be covered in the coating process.

The individual fan-shaped cooling air outlets are processed by means of an exactly parameterized process, in particular a water jet process, so that only the ceramic coat is locally removed and neither chipping off of the surrounding coat nor damage to a metallic bond coat therebelow, in particular an MCrAl—X coat (M=Ni, Co, Fe; X optionally=Y, Ta, Re, Si, in particular M=Ni, Co; X═Y or X═Y+Ta), occurs.

The ceramic coat (TBC) can be removed from the pockets partially, so that a thin coat remains, or completely.

A ceramic coating (TBC) is preferably present in the pocket, but at most at 40%, in particular at most at 20% of the original coat thickness of the ceramic coat in the pocket.

Various options of possible paths for coat removal are possible.

The FIGURE shows the region 4 of a trailing edge 22 of a turbine blade 1 with a blade airfoil region 9 (concave side).

Starting from the trailing edge 22 or shortly behind said trailing edge, there are pockets 7, from which cooling air flows out of the interior of the turbine blade 1 from a hole 6.

Ribs 8 are respectively present between the pockets 7.

The substrate of the turbine blade 1 is a nickel- or cobalt-based alloy.

The bond coat used on the substrate is preferably an NiCoCrAl—X (X, optionally=Y, Ta, Re, Si), which in particular is an overlay coating and not a diffusion coating like an aluminide coating or not a platinum aluminide coating.

An aluminum oxide coat is necessarily and properly formed.

On the substrate thus coated, there is preferably a zirconium-oxide-based single-layer or two-layer ceramic coating, in particular a partially stabilized or fully stabilized ZrO₂ coating.

The coat system composed of the substrate, NiCoCrAl—X, TBC and an oxide coat on the NiCoCrAl—X is present for the entire blade airfoil 9, because, without masking as e.g. in the aforementioned prior art, the region 4 is also coated, i.e. the ribs 8 and the pockets 7.

Therefore, preferably the same coat system composed of the substrate, NiCoCrAl—X, TBC and an oxide coat on the NiCoCrAl—X is present on the ribs 8 and in the pockets 7.

The procedure of the coat removal, at least of the ceramic coating, is presented in individual removal patterns.

The first pattern 10 provides that the coat to be removed in the pocket 7, in particular of the ceramic coat, is removed line by line parallel to the trailing edge 22.

The removal can be started near the trailing edge 22 or near the hole 6.

The jet can be guided over the pocket 7 always from left to right, or from right to left, or the jet can be guided on a serpentine course.

The removal preferably occurs layer by layer in a plurality of passes or occurs all at once over the coat thickness along the line guidance.

The second pattern 13 provides that, beginning from a starting point, preferably at the trailing edge 22, the area of the pocket 7 is traveled on a spiral course according to the pattern of the pockets 7, wherein this can be achieved layer by layer in a plurality of passes or can be achieved all at once over the coat thickness along the line guidance.

The third pattern 16 shows another procedure, in which at least the ceramic coating is removed at most partially from the ribs 8, in one process, and largely or completely from the pockets 7 and the coat removal optionally extends at most partially into the blade airfoil region 9.

This can occur on a line course, as in the first pattern 10, or on a spiral course, as in the second pattern 13.

The removal preferably occurs layer by layer in a plurality of passes or occurs all at once over the coat thickness along the line guidance.

The fourth pattern 19 shows a procedure similar to the first pattern 10, but in said procedure the course of the removal goes beyond the pocket 7 onto the rib 8, although in such a way that part of the ceramic coating completely remains on the rib 8.

The removal preferably occurs layer by layer in a plurality of passes or occurs all at once over the coat thickness along the line guidance.

The fifth pattern 31 shows a slight variation of the first 10 and third 16 patterns, namely that the straight-line guidance of the jet does not run parallel to the trailing edge 22, but rather precisely not parallel to the trailing edge 22, but rather preferably perpendicularly to the trailing edge 22.

It is possible to remove only the pocket 7 from a ceramic coating and or also the ribs 8 therebetween.

This occurs layer by layer in a plurality of passes or occurs all at once over the coat thickness along the line guidance.

In contrast to the other patterns, the sixth pattern 25 shows that here the travel to and removal of the ceramic coating is performed point by point. To accomplish this, pulsing is performed and the jet is moved during the pulse pause.

The individual areas of the point regions 28 overlap in order to produce a continuous area of the pocket 7.

This occurs layer by layer in a plurality of passes or occurs all at once over the coat thickness along the line guidance.

1. A method for removing a coating comprising:
using a jet to remove the coating, at least partially, from at least one pocket in a region of a trailing edge of a turbine blade, and/or
to remove the coating from ribs between the pockets.

2. The method as claimed in claim 1, further comprising:
moving the jet on a straight-line course over an area to be removed.

3. The method as claimed in claim 1, further comprising:
moving the jet on a serpentine course over an area to be removed.

4. The method as claimed in claim 1, further comprising:
moving the jet on a spiral course over an area to be removed.

5. The method as claimed in claim 1,
wherein the jet removes the coating point by point.

6. The method as claimed in claim 1,
wherein no ceramic coating is removed from the ribs.

7. The method as claimed in claim 1,
wherein a ceramic coating is at most partially removed from the ribs.

8. The method as claimed in claim 1,
wherein a ceramic coating is completely removed from the ribs.

9. The method as claimed in claim 1,
wherein no metallic coating is removed from the pockets.

10. A turbine blade, produced as claimed in claim 1, comprising:
a blade airfoil, which is adjoined by a trailing edge with pockets and ribs between the pockets,
wherein a metallic coating is present on the blade airfoil, on the ribs and in the pockets,
wherein a ceramic coating is present on the blade airfoil, at least partially present on the ribs and at least partially present or not present at all in the pockets.

11. The turbine blade as claimed in claim 10,
wherein an NiCoCrAl—X coating is present in the pocket,
wherein X is optional and comprises X═Y, Ta, Re and/or Si.

12. The turbine blade as claimed in claim 10,
wherein a ceramic coating is present or remains in the pocket, and at most at 40%, of the original coat thickness remains in the pocket.

13. The method as claimed in claim 1,
wherein the coating comprises a ceramic coating.

14. The method as claimed in claim 1,
wherein the jet comprises a high-velocity water jet.

15. The method as claimed in claim 1,
wherein the jet is used with abrasive particles to remove the coating.

16. The method as claimed in claim 1,
wherein a ceramic coating is completely removed.

17. The method as claimed in claim 1,
wherein a ceramic coating is removed from a plurality of pockets.

18. The turbine blade as claimed in claim 11,
wherein X is optional and comprises X═Y, Ta, Re and/or Si, with an aluminum oxide coat.

19. The turbine blade as claimed in claim 12,
wherein at most at 20% of the original coat thickness remains in the pocket.
